(19) United States
(12) Patent Application Publication
(10) Pub. No.: US 2006/0017809 A1
(43) Pub. Date: Jan. 26, 2006

(54) Mobile monitoring system

(76) Inventor: Mark D. Carroll, Crown Point, IN (US)

Correspondence Address: BEEM PATENT LAW FIRM, 53 W. JACKSON BLVD., SUITE 1352, CHICAGO, IL, 60604-3787, US

(21) Appl. No.: 10/895,145

(22) Filed: Jul. 20, 2004

(51) Int. Cl. H04N 7/18; G08B 1/00; G08G 1/017; G08B 23/00

(52) U.S. Cl. 348/158; 340/531; 340/937; 340/693.9

(57) ABSTRACT

A self-contained, solar-powered mobile monitoring system is independent of external power sources and remotely accessible using a web browser. The system may include a mobile enclosure that houses a power regulator and batteries, which allow for the distribution and collection of electricity generated by solar panels mounted to the top of the enclosure. Also attachable to the mobile enclosure are weather sensors and an extendable tower. A camera is mountable to the top of the tower to allow for video monitoring, and a mobile camera is further provided for site-specific monitoring. Houseable inside the enclosure is monitoring equipment that collects video from the tower and mobile cameras, and weather data from the weather sensors. Networking equipment housed inside the enclosure make these data wirelessly accessible to local computer users by virtue of an omni-directional antenna mounted to the extendable tower. The data also is transmitted wirelessly to an Internet connection, whereupon the data are routed to a network operations center to allow access by off-site, remote users.

### BACKGROUND OF THE INVENTION

1. Field of the Invention

The present invention relates to mobile monitoring and surveillance systems. More particularly, the present invention relates to a mobile monitoring system, free from physical connections to external devices or systems, that provides a method and system of accessing monitoring data, either through a local computer network or the Internet.

2. Description of the Related Art

Those wishing to monitor a particular location, such as property owners, managers of construction sites, farmers, or researchers, have many options when choosing a monitoring system. Choices narrow if the customer requires mobility and security of the monitoring system, but some products addressing some of these needs are available. Ultimately, however, customers must endure long lead times—typically on the order of weeks—for their monitoring system to be delivered, installed, connected to the local power grid, and activated. Further, customers are usually left to their own devices in managing their system's information output, be it video, audio, environmental data, or a combination thereof. The costs of both providing electricity to a mobile monitoring system and managing the system's information output can be substantial. This is especially true when the conventional power grid cannot be readily accessed, or when the customer requires the ability to quickly and easily move the monitoring system to another location.

The current practice for video monitoring at construction sites, for example, requires cameras that are powered by physical connections to the standard electrical grid, and the employed cameras are often mounted to a fixed tower or pole. Such cameras are cumbersome and time-consuming to install, and difficult to move once installed. Also, video images and other monitoring data are typically output to a dedicated source, such as a closed-circuit video monitor with an attached recorder. Dedicated monitoring sources limit flexibility, as customers are forced to establish dedicated procedures and personnel for monitoring purposes. A solution utilizing computer technology—now nearly ubiquitous at construction sites—would increase monitoring flexibility, thereby decreasing associated costs. Simultaneously, high-speed Internet connections, increasingly available at construction sites via DSL connections provided by Internet service providers such as the local telephone company, are currently under-utilized. Internet availability of monitoring data would allow customers to share necessary information with employees, sub-contractors, and other associates quickly and easily.

But it is difficult, time-consuming, and expensive to increase monitoring flexibility through the delivery of monitoring data to a local computer network; it is even more difficult to establish the ability to monitor a site remotely through the Internet. Both require a relatively large investment in equipment, along with an associated investment for installation and configuration. In effect, what is needed is an “out of the box” monitoring solution that combines independence from the conventional power grid—allowing for fast installation and easy mobility—with the ability to monitor through local computer networks and the Internet.

### BRIEF SUMMARY OF THE INVENTION

The present invention provides a monitoring system that is mobile, free from physical connections, and remotely accessible. This is accomplished by providing a solar power system, freeing the customer from the burden of having to provide power, and providing wireless network connectivity, which allows for unparalleled accessibility through the use of a standard web browser. Furthermore, the invention may be designed for delivery, deployment, and use within 24 to 48 hours as opposed to weeks, and may be installed by a single person.

There are two notable aspects of the invention's mobility aside from that achieved through the use of a solar power system. First, the invention's physical configuration may include an enclosure that houses or otherwise carries all the system's components, and further may include a trailer hitch that allows fast and easy transport of the entire system. Second, in one embodiment, the invention can capture images from a mobile camera used to investigate particular objects or locations. By allowing this increased monitoring capability without requiring a move of the entire system, the mobile camera may provide for greater mobility by allowing flexibility in choosing the system's location. Images from the mobile camera are wirelessly sent to equipment inside the enclosure, and then made available to the customer through a wireless network.

The invention's other monitoring capabilities may include a camera mounted to an extendable tower. This mounted camera provides video images of the monitored site, and can be configured in some embodiments with enhanced security features allowing it to zoom into locations where, for example, a sensor detects motion. Furthermore, the mounted camera's pan, tilt, and zoom features can be interactively controlled using a web browser. This interactivity feature, when coupled with wireless network connectivity, may allow the customer to control the camera through a wireless network using a standard web browser.

The invention may present increased monitoring ability through the use of weather sensors that are mounted outside the enclosure. These sensors transmit data such as temperature, barometric pressure, humidity, and rainfall to a data collector within the enclosure. These data can then be made available to the customer through the use of the wireless network described above which, as with the mounted camera and the mobile camera, are accessible to the customer through the use of a standard web browser.

These and other features and advantages are evident from the following description of the present invention, with reference to the accompanying drawings.

### BRIEF DESCRIPTION OF THE SEVERAL VIEWS OF THE DRAWINGS

FIG. 1 is a perspective view of the invention's exterior components, including a mobile enclosure that can be towed, solar panels that allow for the invention's self-sufficiency, and an extendable tower;

FIG. 2 is a perspective view of a tower camera assembly, including a partial cut-away view of the dome that houses the tower camera, and also including an external sensor that activates the camera upon a given event;

FIG. 3 is a schematic view of the enclosure, showing certain monitoring, networking, and power components of the invention;

FIG. 4 is a functional diagram illustrating the interconnections between certain networking and monitoring components of the invention;

FIG. 5 is a functional diagram illustrating the electrical power connections of the invention;

FIG. 6 is a perspective view of a mobile camera assembly;

FIG. 7 is a functional diagram illustrating ways in which jobsite users and remote users access the monitoring aspects of the invention;

FIG. 8 is an illustration of a webpage used to view and control the various monitoring components of the system, including the tower camera, the mobile camera, an in-enclosure camera.

### DETAILED DESCRIPTION OF THE INVENTION

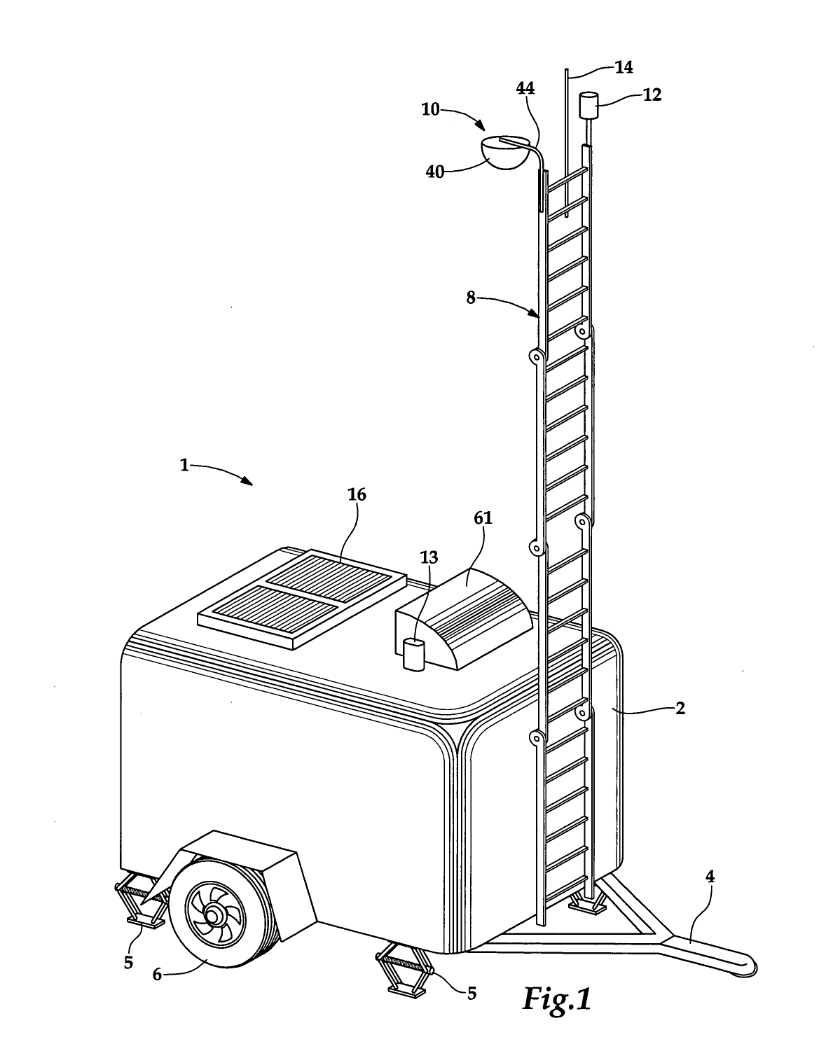

Turning to FIG. 1, a mobile monitoring system 1 (“the system”) in accordance with the present invention is shown. The system generally comprises an enclosure 2, to which a trailer hitch 4 and wheels 6 are attached, making the system mobile. Mountable to the exterior of enclosure 2 are an extendable tower 8, solar panels 16, and rain gauge 13. Attachable to the extendable tower are various monitoring equipment, including a tower camera assembly 10 used for the outdoor video imaging, and weather sensors 12. Also attachable to the extendable tower is an antenna 14, which may be used for transmitting data from the system to a wireless network. Four scissors jacks 5 may be used to support each corner of the enclosure to ensure that the enclosure remains horizontally level and stable. Within the enclosure, a power distribution unit and other monitoring and networking equipment may be housed, as further described below.

In the illustrated embodiment of the system, the enclosure may be a HALS58SA LS CARGO TRAILER made by the Haulin Trailers Division of Forest River, Inc. Extendable tower 8 may be a folding step ladder of aluminum construction that may extend between 8 and 30 feet. For example, the MP6000 SERIES multi-purpose aluminum ladder made by Everlast, which extends to 20 feet, may be employed. The solar panels 16 supply electric power in the range of 60 to 480 Watts; the illustrated embodiment may utilize KC-SERIES solar photovoltaic cells made by Kyocera Corp. that supply electric power at 240 Watts, and lay flat on top of the enclosure prior to the system's arrival at a given site. Scissors jacks 5 may be similar to MODEL 24002D SCISSORS LEVELING RV JACK made by BAL. Once the system arrives at a given site, its location can be determined using a global positioning system (GPS) device, which may be used in conjunction with a solar panel positioning database to determine the optimum compass orientation and tilt angle of the solar panels. This procedure may also yield the optimum angle of the solar panels with reference to magnetic south, and enclosure 2 is positioned accordingly using a compass (not shown).

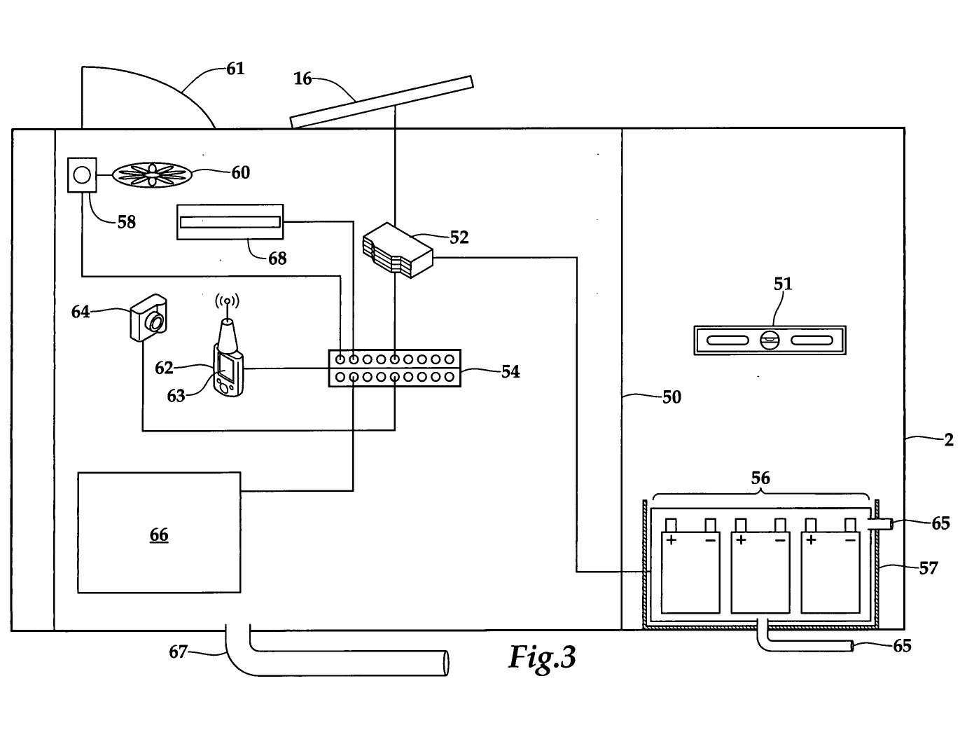

Networking equipment within the enclosure (see FIG. 3) may include a GPS device that operates in conjunction with a tablet PC to send the exact position of the enclosure and the tilt angle of the solar panels to the system's supplier, who is able to advise the customer on the proper position of the enclosure and the tilt angle of the solar panels should the customer need to move the system to another location on the monitored site. A mechanical control device and associated software may give the supplier direct control of the solar panels' tilt angle, eliminating the need for the customer or the supplier's technician to adjust the solar panels, which would be required a minimum of four times a year due to the seasonal variations in the Earth's angle of orbit. The GPS device also may enable the customer to use GPS information for other uses, such as determining precise locations for excavation.

While in the illustrated embodiment only one tower camera assembly 10 is attached to extendable tower 8, more than one tower camera assembly may be attached and utilized as part of the monitoring system. The weather sensors 12 may include a thermometer, a humidity sensor, and a wind sensor. The illustrated embodiment may employ a THGR968 temperature/humidity sensor and a WGR968 anemometer, both manufactured by Oregon Scientific, Inc. Rain gauge 13 may be a RGR968 rain gauge, also manufactured by Oregon Scientific Inc. The weather sensors and rain gauge can all send data wirelessly on a 400 MHz band to a weather data collector 62 inside the enclosure (see FIG. 3), which is also made by Oregon Scientific and is further described below.

The illustrated embodiment of antenna 14 is a BSXL series base station omni-directional antenna made by Comtelco Industries Inc. The antenna may be connected to a wireless router 72 (see FIG. 4) using a co-axial cable, and can transmit data from the wireless router in the 2.4 GHz band. This frequency allows the transmission of data using the 802.11b wireless protocol, which is the wireless networking protocol used in the networking components of the illustrated embodiment. 802.11b is an extension to the IEEE 802.11 wireless networking protocol that provides a data transmission rate of 11 mega-bits per second (Mbps), with a fallback to 5.5, 2 and 1 Mbps. Other standards based on the 802.11 protocol, such as 802.11a or 802.11g, may be used, or a combination of protocols may be used. For example, many wireless networking devices transmit and receive data in both the 802.11b and the 802.11g protocols. Moreover, more efficient wireless networking protocols may in the future replace the 802.11 standard altogether.

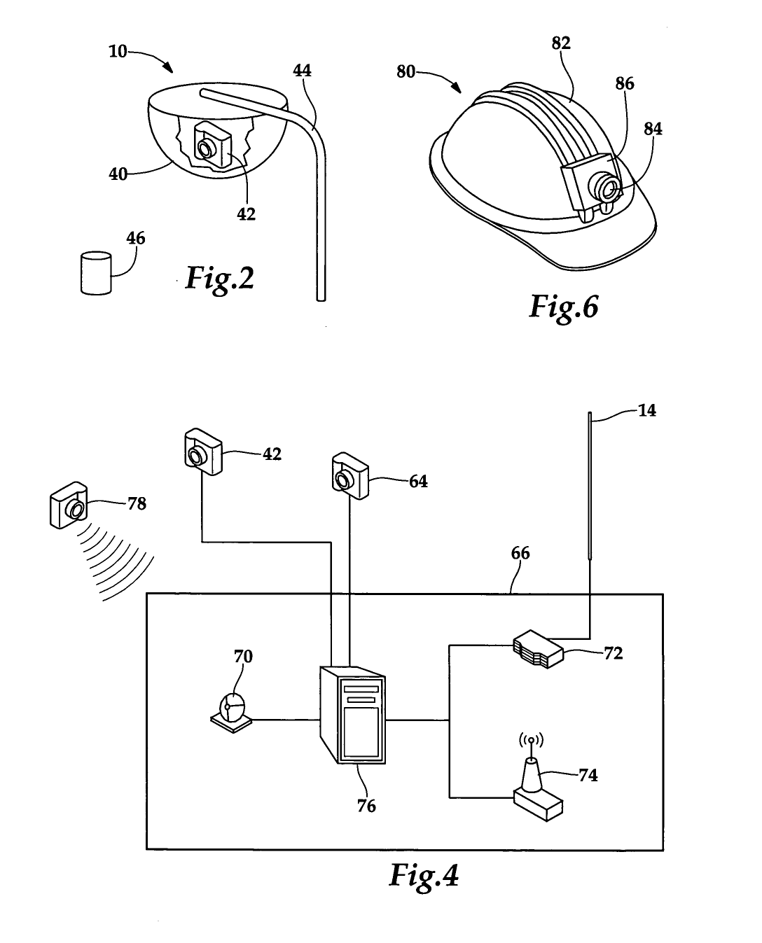

Turning now to FIG. 2, the tower camera assembly 10 may be comprised of camera dome 40, tower camera 42, and pole 44. In the illustrated embodiment of the invention, camera dome 40 may be a Videolarm FDW8C2 camera housing made of plastic, aluminum and stainless steel components, and can provide leads and connectors that allow electrical connections to the camera within. Camera dome 40 may also contain a fan and heater unit (not shown) which ensures that the camera dome does not fog up or ice over during winter. Tower camera 42 may be a Canon VB-C10R video monitoring unit having pan, tilt and zoom capabilities, which can be controlled remotely using a web browser. In the illustrated embodiment, the tower camera may be connected to a camera server 76 inside the enclosure (see FIG. 4) using a Category 5 (Cat-5) cable terminated by RJ-45 connectors, which makes the camera available to a network. Tower camera 42 may instead be connected to a wireless router 72 (see FIG. 4), thus made available to a local-area-network using the camera's own built-in FTP (file-transfer protocol) or HTTP (hyper-text transfer protocol) server. Pole 44 may be used to mount the tower camera assembly to the extendable tower.

Cat-5 cables consist of four twisted pairs of copper wire, and can be used to carry data in a number of networking protocols by supporting frequencies up to 100 MHz and speeds up to 1000 Mbps. RJ-45 connectors are eight-wire connectors that look similar to the ubiquitous RJ-11 connectors used for connecting telephone equipment. Cat-5 cables terminated by RJ-45 connectors are used commonly to connect computers to local-area-networks, or to connect various networking components, such as switches and routers, to each other. Alternatively, Cat-6 cabling may be employed, which provides improved transmission performance and superior immunity from external noise over Cat-5. It is also to be appreciated that new cabling techniques may someday replace the common Cat-5/RJ-45 solution employed in today's computer networks, and that cabling someday may become altogether outmoded due to the rise of totally wireless devices.

Tower camera 42 may utilize an “external device triggering” feature, whereby the tower camera is wirelessly connected to an external sensor 46, for example, a motion sensor or an infrared sensor covering an entrance. The external sensor, once activated, can prompt the camera to pan, tilt, and zoom to a preset location, at which time the camera may record standard video or a still-image.

Turning now to FIG. 3, a schematic view of the interior of enclosure 2 is presented. An inner enclosure 50 may be climate controlled using a thermostat 58 that controls the operation of a fan 60, which can cool the inner enclosure using a ventilation dome 61 and ventilation duct 67. Mountable within the inner enclosure 50 are networking equipment 66, as well as a power regulator 52, a connector block 54, a weather data collector 62, and an indoor camera 64. In the illustrated embodiment, inner enclosure 50 is a rectilinear enclosure made of plywood. Also, the power regulator may be a model PS-30 PROSTAR SOLAR CONTROLLER made by Morningstar Corp., and has a liquid-crystal-display (LCD) screen which displays the total electrical power level of the system. The connector block 54 may be a RADIO SHACK 12-Position European-Style Terminal Strip that accepts electrical wires ranging from 10 to 22 gauge, and may be rated to a maximum of 30 amps and 600 volts per circuit. The batteries 56 may be 12 volt batteries, one or more of which may be used to supply electric power to the system when solar energy is inadequate. For example, to ensure several days of continuous operation give overcast skies, three Deep Cycle Batteries with 180 minutes Reserve, 110 Amp Hours, and 800 Cranking amps, PART # 27MDC-2 made by Duralast, may be used. The batteries may be housed in a sealable plastic container 57 that is positioned outside of the inner enclosure. The plastic sealable container 57 may include battery ventilation system 65 which is used vent the hydrogen gas that builds as the batteries charge. In the illustrated embodiment, the batteries are most efficient if they are positioned on a horizontally leveled surface. A spirit level 51, which may be a 300 mm/12″ TOP READ ALUMINUM LEVEL by Stanley, Inc. or its equivalent, may be used in conjunction with the scissors jacks (see FIG. 1) to ensure that the enclosure's floor, and thus the batteries, remain horizontally level.

Weather data collector 62 allows for the monitoring of the data sent by the weather sensors and the rain gauge by displaying this data in a consolidated fashion on a LCD screen 63. Indoor camera 64 may be used to project images of both the weather data collector's and the power regulator's LCD screens; this allows a user accessing the system to monitor both weather data and the total electric power level. In the illustrated embodiment, the weather data collector may be a WMR112A CABLE FREE WEATHER STATION BASE UNIT made by Oregon Scientific Inc., which wirelessly receives data from weather sensors 12 shown in FIG. 1. Also, the indoor camera may be a Canon VC-C4 camera that allows pan, tilt and zoom capabilities which may be controlled remotely using a web browser. In the illustrated embodiment, the indoor camera contains within its memory the “preset” positions of the weather data collector's and the power regulator's LCD screens. This allows a user to monitor the display of either the weather data collector or the power regulator by selecting the desired item in their web-browser. The indoor camera responds to the user's selection by panning to the appropriate preset position.

In the illustrated embodiment indoor camera 64 is connected to a camera server using a Cat-5 cable terminated with RJ-45 connectors, which in turn makes the camera available to a local-area-network. A camera that can send its images to a network directly also may be employed, as may a weather data collector that can output data directly to a network or a network-attached server. The latter would make the indoor camera unnecessary.

Turning now to FIG. 4, networking equipment 66 housed within the inner enclosure comprises a video receiver 70, a camera server 76, a wireless access point 74, and a wireless router 72. The video receiver, which may be a model VK69A video receiver made by X10 Wireless Technology Inc., may transmit images received wirelessly from mobile camera assembly 80 shown in FIG. 6 to camera server 76, using a video cable. The camera server may be a Canon VB101 NETWORK VIDEO SOLUTION SERVER. As previously mentioned, the camera server may be connected to both the indoor camera 64 and the tower camera 42 using Cat-5 cables terminated with RJ-45 connectors. The camera server may itself be made available to a network by wireless router 72, which may also be connected to the camera server using a Cat-5 cable terminated with RJ-45 connectors. The wireless router may be a model BEFW11 S4 WIRELESS-B BROADBAND ROUTER made by Linksys. Other equivalent models of the above equipment may be used without departing from the invention.

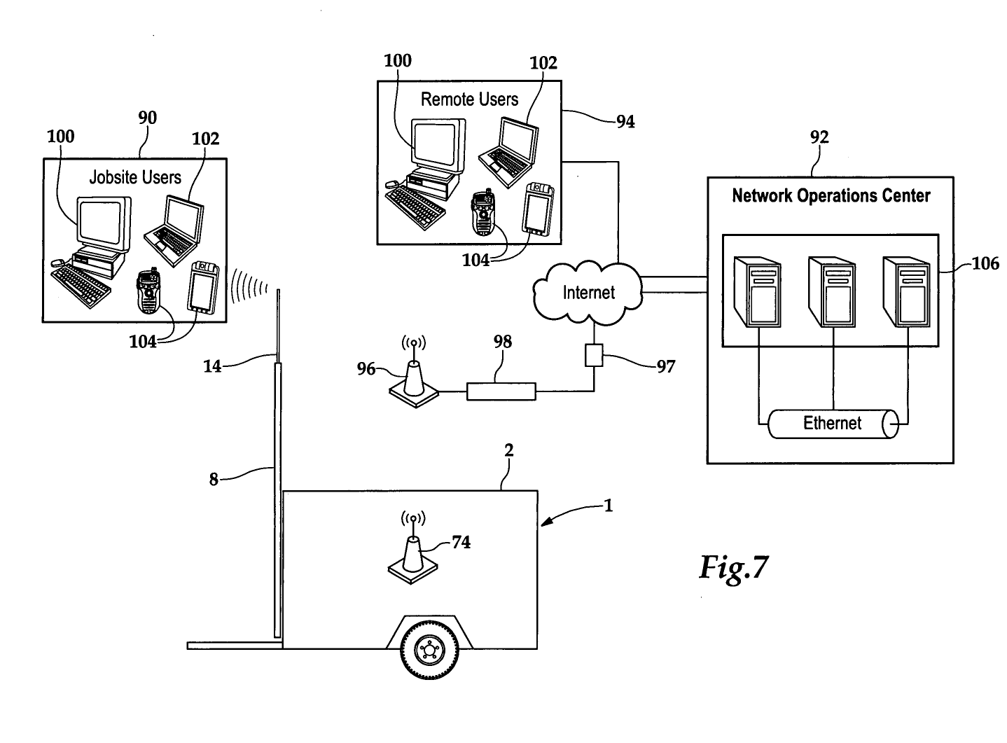

The illustrated embodiment may employ a model BEFW11S4 WIRELESS-B BROADBAND ROUTER made by Linksys. Wireless access point 74 is a networking device that may extend the wireless range of the system by establishing a connection, or a “wireless bridge,” with an identical, remote wireless access point 96 (see FIG. 7) installed near the site's Internet connection 97 (see FIG. 7). The illustrated embodiment may employ a WAP11 WIRELESS-B ACCESS POINT made by Linksys, which may run in “bridge mode” with its remote counterpart in order to establish a wireless connection via the 802.11 networking protocol. As more fully described below, the remote wireless access point may be connected to a network device, such as a switch or a router, which in turn may be connected to the global Internet via a connection provided by an Internet Service Provider.

The system's monitoring capabilities may be enhanced by placing one or more remote cameras 78 that may transmit and receive data using the 802.11 networking protocol. A remote camera 78 may be placed inside buildings, for example, and may be used to monitor a specific location or a special event. More than one remote camera may be used to monitor a location from multiple angles. The remote camera 78 may wirelessly transmit its images to the antenna 14, which may in turn route the images to the other networking equipment heretofore described.

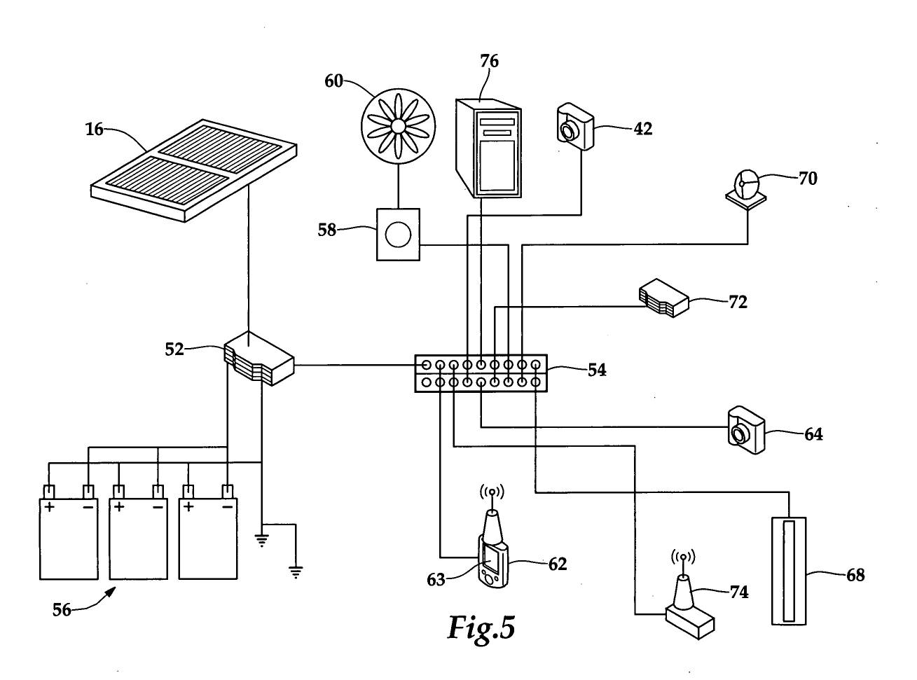

FIG. 5 illustrates the transmission of electrical power within the system. Electricity generated by the solar panels 16 is routed to the power regulator 52, which is used to charge the batteries 56. The power regulator is also connected to a connector block 54, which allows for the delivery of electrical power to the thermostat 58, light 68, weather data collector 62, indoor camera 64, tower camera 42, wireless video receiver 70, wireless router 72, and wireless access point 74. If the batteries' voltage drops below a pre-determined value—10.8 volts in the illustrated embodiment—the power regulator may temporarily divert all electric power to the batteries in order to recharge them. Once the batteries are charged to an acceptable voltage level, the power regulator may send electric power to both the batteries and the connector block, allowing the system to resume normal operation.

Turning now to FIG. 6, a mobile camera assembly 80 may send images to the video receiver 70 shown in FIG. 4. The mobile camera assembly comprises a helmet 82, to which a mobile camera 84 and a power supply 86 are attached. In the illustrated embodiment of the system, the helmet is a standard construction site helmet, but it is to be appreciated that the mobile camera and its power supply may be handheld or carried in another manner. The mobile camera may be a XC18A wireless camera made by X10 Wireless Technology Inc., which may send its images at a frequency of 2.4 GHz. The power supply 86 may be a model XM13A ADDRESSABLE POWER SUPPLY, also made by X10 Wireless Technology Inc., which may include an AC outlet adapter to allow for the power supply's recharge.

Turning now to FIG. 7, users may access monitoring components of the system in two distinct ways: first, by using a local-area-network, and second, through the Internet. In the present embodiment, the monitoring components that a user may access include: (a) the tower camera 42 (see FIG. 2) which allows video monitoring of the site, (b) the indoor camera 64 (see FIG. 3) which allows a user to view both weather data as displayed by the weather data collector 62 and the system's electrical power level as displayed by the power regulator 52, (c) the mobile camera 84 (see FIG. 6) that allows a user to obtain a more detailed view of particular site locations, and (d) all remote cameras 78 (see FIG. 4).

Jobsite users 90 at or near the monitored site may connect to mobile monitoring system 1 by virtue of being connected to a local-area-network. The system may be accessed using a web browser on any device that can receive data wireless via the 802.11b protocol, such as desktop computers 100, laptops 102, and handheld devices 104. Jobsite users connect to the system by virtue of the antenna 14 or, if they are close or inside the enclosure, they may access the system via wireless router 72. The antenna 14 may also allow jobsite users 90 to access Internet connection 97, which may allow the jobsite users to access other Internet services such as their home office, e-mail, project management systems, or any service available on the Internet.

Users out of the range of antenna 14 are considered to be remote users 94, and may connect to mobile monitoring system 1 through the Internet by using “stations” such as desktop computers 100, laptops 102, or handheld devices 104. The remote users may do this by accessing a website hosted on servers 106 at network operations center 92. The website, in turn, may be available via an Internet connection 97, which is provided by an Internet Service Provider (ISP) at a location at or near the monitored site. An Internet router 98 may connect to the remote wireless access point 96 using Cat-5 cables terminated by RJ-45 connectors; this can make the Internet connection available to the remote wireless access point 96. As mentioned, the remote wireless access point may be bridged to the wireless access point 74 via 802.11b wireless protocol; this “bridge” between wireless access point 74 and remote wireless access point 96 may thus make the Internet connection 97 available to jobsite users 90 by virtue of the antenna 14 and the antenna's connection to wireless router 72.

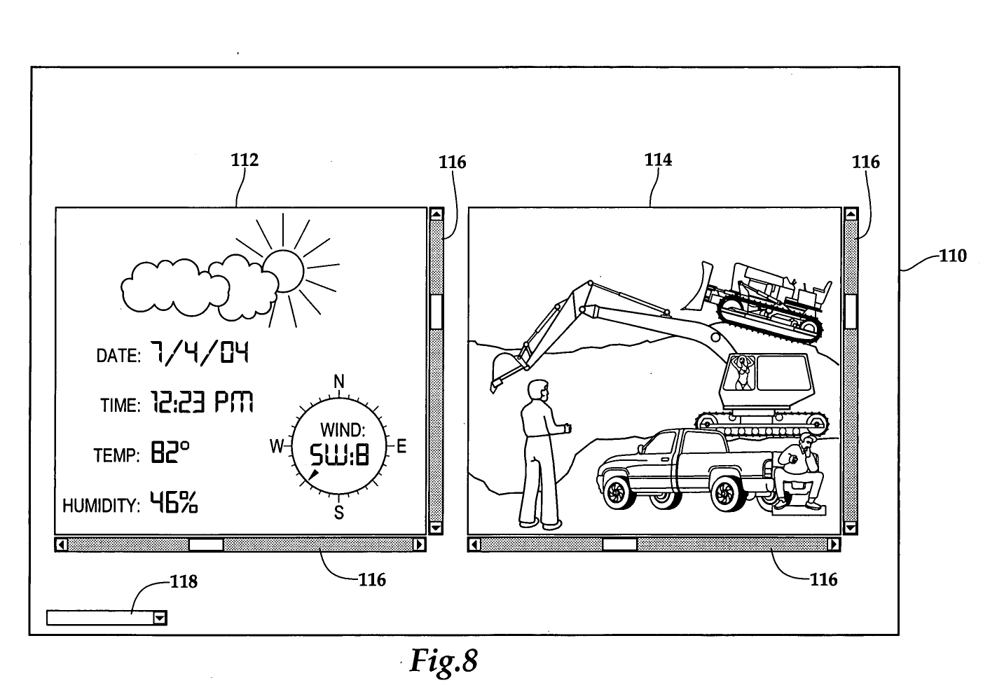

FIG. 8 illustrates a webpage 110 which is hosted at the network operations center and displayed when a remote user uses a web browser to access the appropriate specified Uniform Resource Locater (URL). The webpage invokes two embedded displays 112 and 114 using JAVA Applets; the embedded displays create an interactive connection through the networking components described above. The interactive connection provided allows the remote user to access the images of the tower camera and the indoor camera, and where possible, to control their pan, tilt, and zoom capabilities using scrollbars 116, or to select any available preset camera positions using drop-down menu 118. Further, a remote user may use drop-down menu 118 to access the images of the mobile camera or the remote camera. Jobsite users view images and control the cameras in an identical manner, except that the webpage accessed by jobsite users is hosted on a server at the jobsite, within the jobsite's local-area-network.

The system also may be connected to the Internet and network operations center 92 through a satellite Internet connection, which would eliminate the need for the pair of wireless access points 25 and 34, as well as router 35, since the Internet connection 97 would be established at mobile monitoring system itself.

The mobile monitoring system thus described may be designed to be transported and set up by a single person. The system may be first prepared for transport by placing the solar panels in a flat and secure position, folding and securing the extendable tower, and placing the tower camera assembly, the antenna, and the weather sensors inside the enclosure. The system may then be driven to a designated site while attached to a vehicle of sufficient towing capacity using the trailer hitch. Upon arrival at the designated site, the enclosure may be positioned for optimal sunlight as previously described. The scissors jacks may then be used in conjunction with the spirit level to horizontally level the system. One or more installers may then position the solar panels at the appropriate angle and may partially erect the extendable tower, after which the installer may attach the tower camera assembly, the antenna, and the weather sensors to the tower. The necessary electrical connections between the tower camera and weather monitoring components of the system then may be made according to the foregoing description, using a weather-proof junction box (not shown) mounted to the extendable tower to ensure quick connects and disconnects of the electrical connections. Two guide wires (not shown) then may be connected to the top of the tower, and the tower may be fully erected. The ends of the guide wires then may be connected to eye bolts on the top of the mobile unit to ensure that the tower camera assembly remains stable during high winds, which would otherwise distort viewing capabilities, especially during zooming operations. The entire set-up and activation process of the system may take as little as 15 minutes, and may be accomplished by a single person. Thus, the most significant lead time needed is the time required to tow the unit to the desired location.

Once the system is installed in this manner, it may be activated and made ready for use. An on-site move of the system may be easily accomplished by site personnel—without the need for a dedicated installer—using the trailer hitch. Further, a short move of the system may not require the disassembly of the tower and the components attached to it. Therefore, once the system is activated, an installer may not be needed until the system is to be removed from the site completely. Removal of the monitoring system may require the disassembly of the tower camera assembly, the antenna, and the weather sensors from the tower, the retraction and securing of the tower, and the securing of the solar panels, all of which may be done by a single person in as little as 15 minutes. The system then is ready to be towed to the next site.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A mobile monitoring system, comprising:
a) a transportable base unit having an enclosure;
b) an extendable tower assembly attachable to the base unit;
c) a power distribution unit;
d) monitoring equipment;
e) networking equipment housed in said enclosure for allowing users to wirelessly access said monitoring equipment using a web browser; and
f) a solar power system attachable to the base unit and the power distribution unit.

2. A mobile monitoring system according to claim 1, wherein said monitoring equipment includes a camera mountable to said extendable tower assembly.

3. A mobile monitoring system according to claim 2, wherein said camera includes pan and zoom functions.

4. A mobile monitoring system according to claim 2, wherein said camera can be activated by an external sensor.

5. A mobile monitoring system according to claim 2, and further including a camera server housed in said enclosure for:
a) capturing images from the camera,
b) routing the images from the camera to said networking equipment, and,
c) establishing a means by which users of an associated computer network can control selected camera functions.

6. A mobile monitoring system according to claim 2, wherein said networking equipment includes wireless components for operatively connecting the camera to:
a) a local-area-network, allowing local-area-network users to access images from said camera and control selected camera functions using a web browser, and
b) a remote data center, allowing authorized remote users to access images from said camera and control selected camera functions over the internet using a web browser.

7. A mobile monitoring system according to claim 1, wherein said monitoring equipment includes:
a) a data collector housed in said enclosure, and
b) at least one weather sensor positionable outside the enclosure for transmitting weather data to said data collector.

8. A mobile monitoring system according to claim 7, wherein said networking equipment includes wireless components for operatively connecting the data collector to:
a) a local-area-network, allowing local-area-network users to access said weather data using a web browser,
b) a remote data center, allowing authorized remote users to access said weather data over the internet using a web browser.

9. A mobile monitoring system according to claim 7, and further including a camera housed inside the enclosure and aimed at said data collector for providing an image of the data collector.

10. A mobile monitoring system according to claim 9, and further including a camera server housed in said enclosure for:
a) capturing images from the camera,
b) routing the images from the camera to said networking equipment, and,
c) establishing a means by which users of an associated computer network can control selected camera functions.

11. A mobile monitoring system according to claim 10, wherein said networking equipment includes wireless components for operatively connecting the camera server to:
a) a local-area-network, allowing local-area-network users to access images from the camera and control selected camera functions using a web browser, and
b) a remote data center, allowing authorized remote users to access images from the camera and control selected camera functions over the internet using a web browser.

12. A mobile monitoring system according to claim 1, wherein said monitoring equipment includes:
a) a video receiver within the enclosure, and
b) a mobile camera for wirelessly transmitting remote images to said video receiver.

13. A mobile monitoring system according to claim 12, wherein said networking equipment includes wireless components for operatively connecting the video receiver to:
a) a local-area-network, allowing local-area-network users to access images from said video receiver using a web browser, and
b) a remote data center, allowing authorized remote users to access images from said video receiver over the internet using a web browser.

14. A mobile monitoring system according to claim 1, wherein said monitoring equipment includes at least one remote camera.

15. A mobile monitoring system according to claim 14, wherein said networking equipment includes wireless components for operatively connecting said at least one remote camera to:
a) a local-area-network, allowing local-area-network users to access images from said video receiver using a web browser, and
b) a remote data center, allowing authorized remote users to access images from said video receiver over the internet using a web browser.

16. A mobile monitoring system according to claim 1, and further including an inner-enclosure housed within said enclosure.

17. A mobile monitoring system according to claim 16, wherein said inner-enclosure houses selected networking equipment and monitoring equipment.

18. A mobile monitoring system according to claim 17, wherein the inner-enclosure is environmentally controllable via a ventilation system and a thermostat.

19. A mobile monitoring system according to claim 1, wherein said solar power system comprises at least one solar panel, at least one battery, and at least one power regulator.

20. A mobile monitoring system according to claim 19, and further including a camera housed inside the enclosure and aimed at said data collector for providing an image of the power regulator.

21. A mobile monitoring system according to claim 20, and further including a camera server housed in said enclosure for:
a) capturing images from the camera,
b) routing the images from the camera to said networking equipment, and,
c) establishing a means by which users of an associated computer network can control selected camera functions.

22. A mobile monitoring system according to claim 21, wherein said networking equipment includes wireless components for operatively connecting the camera server to:
a) a local-area-network, allowing local-area-network users to access images from the camera and control selected camera functions using a web browser, and
b) a remote data center, allowing authorized remote users to access images from the camera and control selected camera functions over the internet using a web browser.

23. A mobile monitoring system according to claim 1, wherein said monitoring equipment includes:
a) a camera mounted to said extendable tower assembly,
b) a data collector housed in said enclosure and at least one weather sensor positionable outside the enclosure for transmitting weather data to said data collector,
c) a video receiver within the enclosure and a mobile camera for wirelessly transmitting remote images to said video receiver, and
d) at least one remote camera.

24. A mobile monitoring system according to claim 23, wherein said networking equipment include a camera server and wireless components that operatively connect the camera, the data collector, the video receiver, and the remote camera to:
a) a local-area-network, allowing local-area-network users to access images from the camera and control selected camera functions using a web browser, and
b) a remote data center, allowing authorized remote users to access images from the camera and control selected camera functions over the internet using a web browser.

25. A mobile monitoring system according to claim 1, and further including a light for illuminating the interior of the enclosure.

26. A mobile monitoring system according to claim 1, wherein said networking equipment transmits data using a wireless router employing the IEEE 802.11 protocol.

27. A mobile monitoring system according to claim 1, wherein said networking equipment can transmit data to a remote data center using a satellite dish and a satellite internet provider.

28. A network for accessing and controlling a mobile monitoring system, said network comprising:
a) networking equipment housed in an enclosure of said mobile monitoring system for allowing users to access monitoring components of said mobile monitoring system using a web browser;
b) a remote user station;
c) a jobsite user station;
d) a network operations center; and
e) wireless networking equipment inside the enclosure for operatively connecting the monitoring components to:
i. a local-area-network, allowing users at said jobsite user station to access and control selected parts of the monitoring system, and
ii. an internet connection, allowing authorized users at said remote user station to access and control selected parts of the monitoring system via the internet.

29. A network according to claim 28, wherein said remote users access the mobile monitoring system through a website established at the network operations center.

30. A network according to claim 28, wherein said monitoring components include a camera, and wherein said networking equipment housed in the enclosure includes a camera server that is operatively connected to said camera, and wherein the camera server provides the means for controlling selected camera functions.

31. A network according to claim 30, wherein said wireless networking equipment operatively connects the camera server to said local-area-network for allowing users at said jobsite user station to control selected functions of the camera using a web browser, and to said internet connection for allowing users at said remote user center and said network operations center to control selected functions of the camera using a web browser.

32. A network according to claim 30, wherein said camera includes pan and zoom functions.

33. A network according to claim 28, wherein said camera can be activated by an external sensor.

34. A network according to claim 28, wherein said monitoring components include at least one weather sensor, and wherein said wireless networking equipment operatively connect the at least one weather sensor to said local-area-network for allowing users at said jobsite user station to monitor said at least one weather sensor, and to said internet connection for allowing users at said remote user center and said network operations center to monitor said at least one weather sensor said using a web browser.

35. A network according to claim 28, wherein said monitoring components include a mobile camera, and wherein said wireless networking equipment operatively connect the mobile camera to networking equipment housed in said enclosure and also operatively connect the networking equipment housed in said enclosure to said local-area-network for allowing users at said jobsite user station to view images from the mobile camera, and to said internet connection for allowing users at said remote user station and at said network operations center to view images from the mobile camera using a web browser.

36. A network according to claim 28, wherein said monitoring components include at least one remote camera, and wherein said wireless networking equipment operatively connect said at least one remote camera to networking equipment housed in said enclosure and also operatively connect the networking equipment housed in said enclosure to said local-area-network for allowing users at said jobsite user station to view images from the mobile camera, and to said internet connection for allowing users at said remote user station and at said network operations center to view images from the at least one remote camera using a web browser.

37. A network according to claim 28, wherein said monitoring components include a camera, at least one weather sensor, a mobile camera, and at least one remote camera, and wherein said wireless networking equipment operatively connect said camera, said at least one weather sensor, and said mobile camera to said jobsite user station, remote user center, and network operations center, allowing users to view images from the camera, data from the weather sensor, and images from the mobile camera.

38. A monitoring method, comprising:
a) providing a wireless link to networking equipment housed in an enclosure of a mobile monitoring system for allowing users to access monitoring components of said system from a remote user station, a jobsite user station, and a network operations center;
b) accessing and controlling by local-area-network users at said jobsite user station of selected parts of the monitoring system via a local-area-network;
c) accessing and controlling by users at said remote user station and said network operations center of selected parts of the monitoring system via the internet.

39. A method according to claim 38, wherein said step of allowing users to access the monitoring components includes the use of a camera, and wherein said step of providing a wireless link comprises operatively connecting the camera to networking equipment housed in said enclosure and operatively connecting the networking equipment housed in said enclosure to said local-area-network for allowing users at said jobsite user station to control selected camera functions and to the internet for allowing users at said remote user station and said network operations center to control selected camera functions using a web browser.

40. A method according to claim 39, wherein said step of allowing control of selected camera functions includes panning and zooming.

41. A method according to claim 39, wherein step of activating said camera is achievable using an external sensor.

42. A method according to claim 38, wherein said step of allowing users to access the monitoring components includes the use of at least one weather sensor, and wherein said step of providing a wireless link comprises operatively connecting the at least one weather sensor to networking equipment housed in said enclosure and operatively connecting the networking equipment housed in said enclosure to said local-area-network for allowing users at said jobsite user station to monitor said at least one weather sensor and to the internet for allowing users at said remote user station and said network operations center to monitor said at least one weather sensor said using a web browser.

43. A method according to claim 38, wherein said step of allowing users to access the monitoring components includes the use of a mobile camera, and wherein said step of providing a wireless link further comprises operatively connecting the mobile camera to networking equipment housed in said enclosure and operatively connecting the networking equipment housed in said enclosure to said local-area-network for allowing local-area-network users at said jobsite to view images from the mobile camera and to the internet for allowing said remote users and said network operations users to view images from the mobile camera using a web browser.

44. A method according to claim 38, wherein said step of allowing users to access the monitoring components includes the use of at least one remote camera, and wherein said step of providing a wireless link further comprises operatively connecting the at least one remote camera to networking equipment housed in said enclosure and operatively connecting the networking equipment housed in said enclosure to said local-area-network for allowing local-area-network users at said jobsite to view images from the at least one remote camera and to the internet for allowing said remote users and said network operations users to view images from the at least one remote camera using a web browser.

45. A method according to claim 38, wherein said step of allowing users to access the monitoring components includes the use of a camera, at least one weather sensor, and a mobile camera, and wherein said step of providing a wireless link comprises operatively connecting the camera, the at least one weather sensor, and the mobile camera to networking equipment housed in said enclosure and operatively connecting the networking equipment housed in said enclosure to said jobsite user station, said remote user station, and said network operations center allowing users to view images from the camera, data from the weather sensor, and images from the mobile camera using a web browser.

46. A monitoring system, comprising:
a) means for providing a wireless link to networking equipment housed in an enclosure of a mobile monitoring system for allowing users to access monitoring components of said system using a web browser from a remote user station, a jobsite user station, and a network operations center;
b) means for users at said jobsite user station to access and control selected parts of the monitoring system via a local-area-network, and means for users at said remote user station and network operations center to access and control selected parts of the monitoring system via the internet.

47. A system according to claim 46, wherein said monitoring system includes a camera, and wherein said means for providing a wireless link comprises means for operatively connecting the camera to networking equipment housed in said enclosure and for operatively connecting the networking equipment housed in said enclosure to said local-area-network for allowing users at said jobsite user station to access images and control selected functions of the camera using a web browser, and to the internet for allowing users at said remote user station and said network operations center to access images and control selected camera functions using a web browser.

48. A system according to claim 47, wherein said selected camera functions include pan and zoom functions.

49. A system according to claim 47, wherein said camera can be activated by an external sensor, such as an infrared sensor or motion detector.

50. A system according to claim 46, wherein said monitoring system includes at least one weather sensor and wherein said means for providing a wireless link comprises means for operatively connecting the at least one weather sensor to said local-area-network for allowing local-area-network users at said jobsite to monitor said at least one weather sensor and to the internet for allowing said remote users and said network operations users to monitor said at least one weather sensor said using a web browser.

51. A system according to claim 46, wherein said monitoring system includes a mobile camera, and wherein said means for providing a wireless link further comprises means for operatively connecting the mobile camera to networking equipment housed in said enclosure and for operatively connecting the networking equipment housed in said enclosure to said local-area-network for allowing users at said jobsite user station to access images from the mobile camera using a web browser, and to the internet for allowing users at said remote user station and said network operations center to access images from the mobile camera functions using a web browser.

52. A system according to claim 46, wherein said monitoring system includes at least one remote camera, and wherein said means for providing a wireless link further comprises means for operatively connecting the at least one remote camera to networking equipment housed in said enclosure and for operatively connecting the networking equipment housed in said enclosure to said local-area-network for allowing users at said jobsite user station to access images and control selected functions of the at least one remote camera using a web browser, and to the internet for allowing users at said remote user station and said network operations center to access images and control selected functions of the at least one remote camera using a web browser.

53. A system according to claim 46, wherein said monitoring system includes a camera, at least one weather sensor, a mobile camera, and at least one remote camera, and wherein said means for providing a wireless link comprises means for operatively connecting the camera, the at least one weather sensor, the mobile camera, and the at least one remote camera to said local-area-network for allowing local-area-network users at said jobsite to access said camera, said at least one weather sensor, said mobile camera, and said at least one remote camera and to the internet for allowing said remote users and said network operations users to access said camera, said at least one weather sensor, said mobile camera, and said at least one remote camera using a web browser.
